(19) United States
(12) Patent Application Publication
(10) Pub. No.: US 2015/0047482 A1
(43) Pub. Date: Feb. 19, 2015

(54) CUTTING BLADE HAVING A MEANS FOR PRODUCING AN AIR FLOW

(71) Applicant: GEA Food Solutions Germany GmbH, Biedenkopf-Wallau (DE)

(72) Inventors: Stefan Stadtmüller, Sulzberg (DE); Alexander May, Waltenhofen (DE)

(21) Appl. No.: 14/384,230

(22) PCT Filed: Mar. 14, 2013
(86) PCT No.: PCT/EP2013/055289

§ 371 Date: Sep. 10, 2014

(30) Foreign Application Priority Data
Mar. 14, 2012 (DE) 10 2012 004 960.9

(51) Int. Cl. B26D 7/32; B26D 7/06; B26D 1/00

(52) U.S. Cl. CPC B26D 7/32; B26D 1/0006; B26D 7/0658
USPC 83/24; 83/98

(57) ABSTRACT

The present invention relates to a rotating cutting blade, which cuts a plurality of food slices from a bar of food, wherein the cutting blade is provided on a blade holder. The present invention further relates to a slicing device having the cutting blade according to the invention, a method for slicing a bar of food, wherein a rotating cutting blade cuts a plurality of food slices from a bar of food, and a method for slicing a bar of food, wherein a rotating cutting blade, which is arranged on a blade holder, cuts a plurality of food slices from a bar of food and an interleaver is arranged between two food slices.

The present invention relates to a rotating cutting blade which cuts a plurality of food slices from a food slab, wherein the cutting blade is provided on a blade receiving means. In addition, the present invention relates to a slicing device comprising the cutting blade according to the invention and to a method for slicing a food slab where a rotating cutting blade separates a plurality of rood slices from a food slab as well as to a method for slicing a food slab where a rotating cutting blade, which is arranged on a blade receiving means, separates a plurality of food slices from, a food slab and an interleaves is arranged between two food slices.

These types of cutting blades, devices and methods are adequately known from the prior art and are used for the purpose of separating food slices from a food slab, for example a slab of sausage, cheese or ham. In the majority of cases, after slicing the food slices fail a certain distance onto a support, for example, a delivery table, and/or onto food slices that have already teen cut. There they are configured to form one portion and are then transported away. In particular in the case of large food slices, daring said falling movement and/or even when the respective food slice is being cut from the food slab, the respective food slice is deformed in an unwanted manner, for example, is folded or undulated. However, as an alternative to this, it can be desirable to move the initially substantially plane food slice into a three-dimensional form, for example to fold it.

The object of the present invention was consequently to provide a cutting blade by way of which a food slice is stabilized and/or formed in a desired form during the slicing process and/or during its flight.

The object is achieved by way of a rotating cutting blade which cuts a plurality of food slices from one or several food slabs, wherein the cutting blade is provided on a blade receiving means and at least one means is provided on the cutting blade and/or on the blade receiving means and/or that a cutting blade and/or the blade receiving means are developed in a corresponding manner such that one or several gas flows, in particular air flows, are produced which form each food slice during the cutting process and/or thereafter and/or stabilize it in a desired form at lease in part and/or at times and/or influence the flight of the slice and/or apply an interleaver to a food slice and or stabilize the cutting blade.

The statements made concerning said object of the present invention are equally applicable to the other objects of the present invention and vice versa.

The present invention relates to a rotating cutting blade which slices a plurality of food slices from a foodstuff. This type of cutting blade can be, for example, a circular blade, a sickle blade or a spiral blade. The blade is preferably a circular blade which is moved along an orbital path and is rotated multiple times about its own center axis when slicing a food slice. The blade, as a rule, is arranged on a blade receiving means which is part of a rotor of a slicing device. In the case of such slicing devices, a food slab is conveyed along a forward feed path in a continuous or intermittent manner in the direction of the cutting blade. Said cutting blade separates food slices off from the front end of the food slab. The thickness of a food slice is determined by the amount of forward feed by which the food slab continues to be conveyed whilst the cutting blade is not situated in cutting engagement with the food slab. Once sliced, the food slices fall, in particular along a flight curve, onto a delivery table and/or onto a food slice that has already been sliced where they are configured to form one portion and are then conveyed away.

According to the invention, at least one means is now provided on the cutting blade and/or on the blade receiving means and/or that a cutting blade and/or the blade receiving means are developed in a corresponding manner such that a gas flow, in particular air flow, is produced which forms each food, slice daring the cutting process and/or thereafter, i.e. as it falls onto the delivery table and/or onto food slices that are already there, and/or stabilizes it in a desired form at least in part and/or at times. The gas flow, in particular air flow, in this case, flows along the already sliced part of the food slice and/or along the completely sliced food slice which is preferably in flight and forms and/or stabilizes it. A pulsating or a continuous gas flow, in particular air flow, can be produced by the means. The air flow can exert a pulse onto the food slice and/or can generate a negative pressure on one side of the food slice, as a result of which the food slice is formed and/or stabilized in its desired form. The air flow can also be used to stabilize the cutting blade during its rotation such that, for example, it oscillates less.

As an alternative to this or in addition to it, the gas flow, in particular air flow, which is produced by the means, is used for the purpose of applying an interleaver to each sliced food slice. An interleaver is a piece of paper or a paper-similar substance which is arranged between two food slices in order to reduce the adhesion thereof.

The means for producing the gas flow, in particular air flow can be produced from an arbitrary material, it preferably being produced from metal, in particular steel.

The means is preferably a projection which is provided, on the side of the cutting blade which is remote from the food slab. For example, the means can be a sheet part which is fastened on the cutting blade, for example in a bonded manner, in particular as a result of welding or gluing and/or in a force-fitting and/or form-fitting manner, for example by means of screws, rivets or the like. In a particularly preferred manner, the cutting blade and the means are provided in one piece. The means is preferably created by a local material accumulation or by forming the material from which the cutting blade is produced. In particular, the means is a bulge which is provided in the surface of the cutting blade.

The means is preferably at least one vane or a vane-like structure which produces the gas flow, in particular air flow. In a particularly preferred manner, the alignment of the said vane is modifiable relative to the cutting blade. The size and/or the direction of the gas flow, in particular air flow, can be influenced as a result.

The means preferably rotates at the same speed as the cutting blade. In the case of a circular blade which can rotate about its center axis when slicing off a food axis in a multiple manner, the gas flow, in particular air flow which is produced by the means can be influenced by the number of revolutions which the cutting blade performs when cutting a food slice.

As an alternative to this, the means rotates at a different speed to the cutting blade, the drive of the means, however, preferably being diverted from the rotation of the cutting blade. For example, a gear unit or a coupling can be provided between the cutting blade and the means by way of which the speed of the means is adjusted.

A further object of the present invention is a slicing device on which the cutting blade according to the invention is arranged.

The statements made concerning said object of the present invention are equally applicable to the other objects of the present invention and vice versa.

Yet another object of the present invention is a method for slicing from one or several food slabs, where a rotating cutting blade separates a plurality of food slices from a food slab, where the food slice which has been sliced in part and/or completely is acted upon by one or several gas flows, in particular air flows which form it and/or stabilize it in a desired form and/or influence the flight of the slice and/or stabilize the cutting blade and/or remove the gas flow contaminants, in particular air flow contaminants from the cutting region, in particular the depositing region.

The statements made concerning said object of the present invention are equally applicable to the other objects of the present invention and vice versa.

The gas flow, in particular air flow is preferably produced such that it flows along between the at least partly sliced food slice and the cutting blade. In this case, it forms the food slice and/or stabilizes it in the desired form in each case.

The gas flow, in particular the air flow, is preferably influenced by the speed of a circular blade which separates the food slices from the front end of the food slab.

According to the invention, the produced air flow can also be used for the purpose of removing, in particular blowing away contaminants which collect in the cutting region and/or the delivery region. These types of contaminants are, for example, particles which are torn from the product to be sliced.

An additional object of the present invention is a method for slicing a food slab where a rotating cutting blade, which is arranged on a blade receiving means, separates a plurality of food, slices from a food slab, wherein an interleaves is arranged between two food slices, where the interleaver is applied to a food slice as a result of an air flow which is produced by a means which is arranged on the cutting blade and/or the blade receiving means.

The statements made concerning said object of the present invention are equally applicable to the other objects of the present invention and vice versa.

Yet another object of the present invention is a method for slicing one or several food slabs where a rotating cutting blade, which is arranged on a blade receiving means, separates a plurality of food slices (12) from one or several food slabs (11), wherein an interleaver is arranged between two food slices, where the interleaver is applied to a food slice as a result of an air flow which is generated by a means which is arranged on the cutting blade and/or the blade receiving means.

The statements made concerning said, object of the present invention are squally applicable to the other objects of the present invention and vice versa.

An additional substance is preferably applied onto the blade surface and/or product surface, for example a disinfecting/cleaning means or a replacement gas, by means of the gas flow/flows, in particular air flow/flows.

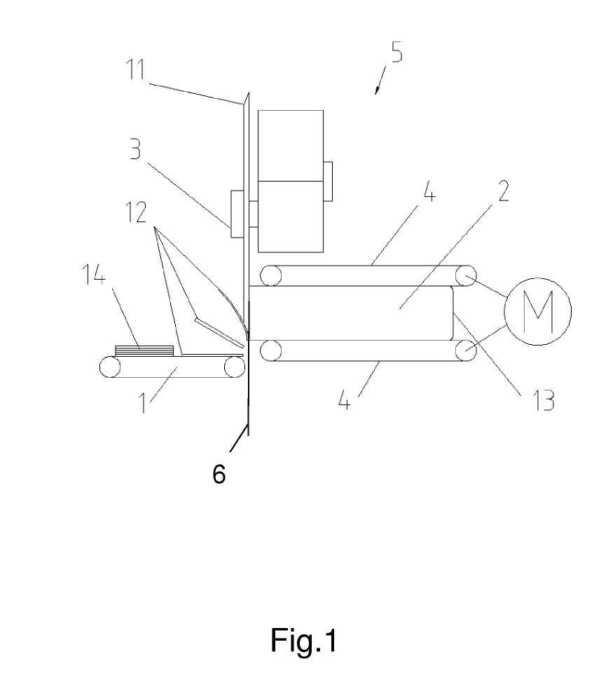

The invention is explained below by way of FIGS. 1-4. Said explanations are simply as an example and do not restrict the general inventive concepts. The explanations are applicable equally to all one objects of the present invention.

FIG. 1 shows the slicing device according to the invention.

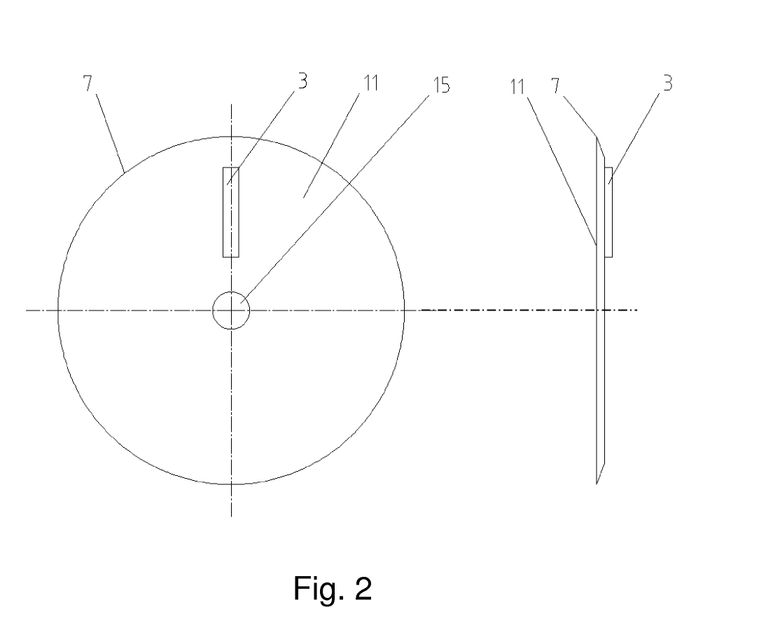

FIGS. 2-4 show in each case an embodiment of the cutting blade according to the invention.

FIG. 1 shows an embodiment according to the invention of a slicing device. The slicing device 5 comprises a blade 11 which cuts a food slab 2 into food slices 12. To this end, each food slab 2 is conveyed, by way of a conveying means 4, in this case two conveyor belts 4, continuously or intermittently in the direction of the cutting plane 6 of the blade 11. After slicing, the food slices, as a rule, fall onto a delivery table 1 which is provided with conveying means on which said food slices are configured in each case to form one portion 14, in this case one stack. Said portions 14 are then removed from the cutting blade region and subsequently packaged. The expert recognizes that several food slabs are able to be sliced at the same time. The slice thickness is produced from the forward feed path of the food slab between two cuts. At a constant blade rotation speed, the slice thickness is controlled by the speed of the forward feed of the food slab. The slicing device can comprise one gripper (not shown) per forward feed path which grips the rear end 13 of the food slab 2 prior to or during slicing and stabilizes the sane during slicing.

According to the invention, there is provided a means 3, in this case at least one projection, which co-rotates with the cutting blade 11 at the same speed and in this case produces a gas flow, in particular an air flow which stabilizes and/or forms the food slice which has been sliced at least in part, in particular completely, in a desired form. The gas flow, in particular air flow preferably flows for this purpose along the side of the food slice that faces the food slab, in particular between the food slice and the cutting blade. The gas flow, in particular air flow can be pulse-like and/or continuous.

FIG. 2 shows a first embodiment of the cutting blade 11 according to the invention, in this case a circular blade. Said blade comprises a cutting edge 7 by way of which the food slice 12 is separated from the food slab 2. The circular blade is rotated during cutting both about its center axis 15 and about an orbital axis (not shown), the speed of the cutting blade 11 about its center axis 15 preferably being a multiple of its speed about the orbital axis. According to the invention, the cutting blade comprises a means 3 by way of which, during its rotation, in particular about its center axis 15, a gas flow, in particular air flow is produced. Said preferably pulse-like and/or continuous air flow forms and/or stabilizes each food slice which has been at least partially sliced, in particular during its flight onto the delivery table. As a result of the air flow, the sliced food slice can be held, for example, in a substantially plane form, which is an advantage, for example, for a stacked or shingled portion. However, by way of the gas flow, in particular air flow, it is also possible to form, for example to fold and/or to undulate the food slice, in particular during its flight onto the delivery table. In the present case, the means is a projection which is arranged on the side of the cutting blade which is remote from the food slab. The means 3 can be a sheet part which is fastened on the cutting blade 11 as a result of, for example, welding, gluing and/or by means of screws, rivets or the like. However, the means 3 is preferably provided integrally with the cutting blade and, for example, can be produced as a result of forming for example a bulge or a material accumulation, from the material of the cutting blade. The integral embodiment of the cutting blade according to the invention has proved to be particularly hygienic.

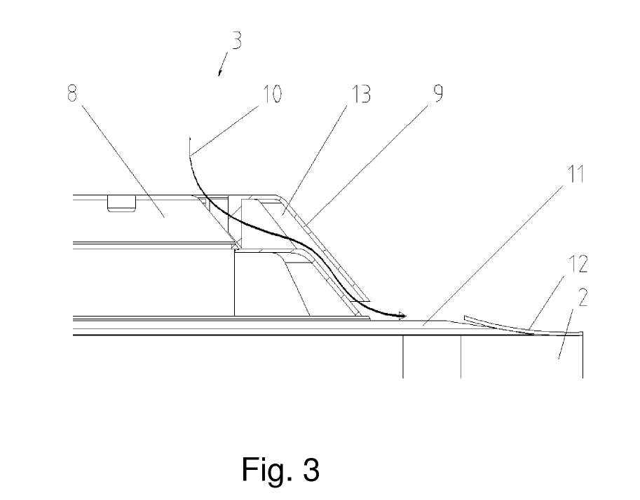

FIG. 3 shows a further embodiment of the cutting blade 11 according to the invention. In the present case, the means 3 comprises at least one, preferably a plurality of vanes 13, which are provided in each case on a cover 9 in particular between the cover 9 and the cutting blade 11. The means 3 is preferably a fan wheel-like structure. The means 3, in the present case, can be arranged both on the cutting blade 11 and on the blade receiving means 8 and rotates at the same speed as the cutting blade 11. As a result of said rotation, the vanes 13 produce an air flow 10 which, according to the invention, stabilizes the food slice 12 in a desired position or forms said food slice. Each vane 13 is preferably provided so as to be movable on the cover 9 or on the cutting blade 11 such that the sire and the direction of the air flow 10 produced is able to be modified. The expert recognizes that the air flow 10 is able to flow in the reverse direction.

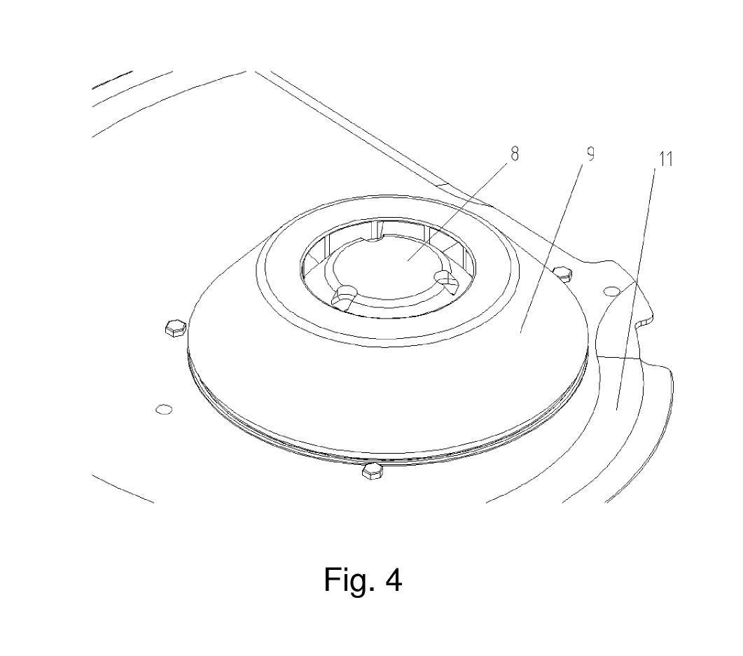

FIG. 4 essentially shows the cutting blade according to figure 3, in the present case the cutting blade 11 being realized as a sickle blade. Apart from this, reference is made to the statements according to FIG. 3.

### LIST OF REFERENCES

1 Delivery table
2 Food slab
3 Means for producing a gas flow, in particular an air flow
4 Conveying means
5 Slicing device
6 Cutting plane
7 Cutting edge of the cutting blade 11
8 Rotor, blade receiving means
9 Cover
10 Gas flow, in particular air flow
11 Blade, circular blade
12 Food slices
13 Rear end
14 Portion
15 Center axis of the cutting blade

What is claimed is:

1. A rotating cutting blade which cuts a plurality of food slices from one or several food slabs,
wherein the cutting blade is provided on a blade receiving means,
wherein at least one means is provided on the cutting blade and/or on the blade receiving means and/or in that a cutting blade and/or the blade receiving means are developed in a corresponding manner such that, as a result of the rotation of the cutting blade, one or several gas flows, in particular air flows, are produced which form each food slice during the cutting process and/or thereafter and/or stabilize the food slice in a desired form at least in part and/or at times and/or which apply an interleaver to a food slice.

2. The rotating blade as claimed in claim 1, wherein the means is at least one projection which is arranged on the side of the cutting blade which is remote from the food slab.

3. The rotating blade as claimed in claim 1, wherein the cutting blade and the means are provided in one piece.

4. The rotating blade as claimed in claim 1, wherein the means is at least one vane which produces the air flow.

5. The rotating blade as claimed in claim 1, wherein alignment of the vane is modifiable relative to the cutting blade.

6. The rotating blade as claimed in claim 1, wherein the means rotates at a same speed as the cutting blade,

7. The rotating blade as claimed in claim 1, wherein the means rotates at a different speed to the cutting blade.

8. The rotating blade as claimed in claim 1, wherein the means rotates in an opposite direction to the cutting blade.

9. The rotating blade as claimed in claim 1, wherein the means rotates in a same direction of rotation as the cutting blade.

10. The rotating blade as claimed in claim 1 wherein the cutting blade is a circular blade which circulates along an orbital path.

11. A slicing device comprising a cutting blade according to claim 1,

12. A method for slicing from one or several food slabs, where a rotating cutting blade separates a plurality of food slices from a food slab,
wherein a food slice which has been sliced in part and/or completely is acted upon by one or several gas flows, in particular air flows, which form the food slice and/or stabilize the food slice in a desired form and/or influence the flight of the slice wherein the gas flow is produced by the rotating cutting blade.

13. The method as claimed in claim 12, wherein the gas flow is provided between the food slice and the cutting blade.

14. A method for slicing one or several slabs of food where a rotating cutting blade, which is arranged on a blade receiving means, separates a plurality of food slices from one or several food slabs,
wherein an interleaver is arranged between two food slices,
wherein the interleaver is applied to a food slice as a result of an air flow which is produced by a means which is arranged on the cutting blade and/or the blade receiving means, and as a result of the rotation of the cutting blade.

15. The method as claimed in claim 14, wherein an additional substance is applied onto the blade surface and/or product surface by means of the gas flow/flows, in particular air flow/flows.

16. The rotating blade as claimed in claim 2, wherein the cutting blade and the means are provided in one piece.

17. The rotating blade as claimed in claim 16, wherein the means is at least one vane which produces the air flow.

18. The rotating blade as claimed in claim 17, wherein alignment of the vane is modifiable relative to the cutting blade.

19. The rotating blade as claimed in claim 18, wherein the means rotates at a same speed as the cutting blade.

20. The rotating blade as claimed in claim 19, wherein the means rotates in a same direction of rotation as the cutting blade.
